(19) United States
(12) Patent Application Publication
(10) Pub. No.: US 2006/0155465 A1
(43) Pub. Date: Jul. 13, 2006

(54) Method for route guidance on mobile terminal capable of interworking scheduling and navigation functions

(75) Inventors: Suk-In Jung, Seoul (KR); Jong-Hyun Kim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/201,659

(22) Filed: Aug. 10, 2005

(30) Foreign Application Priority Data
Jan. 7, 2005 (KR) 1675/2005

(51) Int. Cl. G01C 21/26

(52) U.S. Cl. 701/209; 701/204

(57) ABSTRACT

Disclosed is a mobile terminal capable of interworking a navigation function with a schedule management function. If a user previously registers schedule information including the origin, destination, appointment date/time and schedule alarm time, the mobile terminal will automatically generate an alarm when the schedule alarm time is reached on the date of appointment. Also, the mobile terminal displays an optimal route to the destination and time information to help the user to reach the destination at a desired time. To display the time information (for example, remaining time to reach the destination), the mobile terminal measures the traveling speed of the user and calculates the remaining time to reach the destination based on the measured traveling speed.

### PRIORITY

This application claims priority to an application entitled “Method for Route Guidance on Mobile Terminal Capable of Interworking Scheduling and Navigation Functions” filed with the Korean Intellectual Property Office on Jan. 7, 2005 and assigned Serial No. 2005-1675, the contents of which are incorporated herein by reference.

### BACKGROUND OF THE INVENTION

1. Field of the Invention

The present invention relates to a mobile terminal having a navigation function, and more particularly to a method for route guidance on a mobile terminal capable of interworking a navigation function with a scheduling function that provides information about scheduled departure and arrival times.

2. Description of the Related Art

With the development of mobile communication technologies, mobile terminals such as PCS, IMT-2000 and PDA phones have become more integrated than pre-existing mobile phones for simple voice calls to implement additional functions or services, including message exchange, wireless Internet access, schedule management and navigation services.

Mobile users can input, edit and store their personal schedules for specified dates and times in mobile terminals. The users can read stored schedule information to make sure everything gets done on time. Mobile terminals generally have a schedule management function for reminding the users of the inputted schedules or appointments at every date and time specified. When a user sets an alarm time for a schedule, an alarm is generated in a preset manner when the alarm time is reached on the date that is also specified. The user can set a schedule alarm using the schedule management function to be reminded of any activity (departure) for the schedule in time or beforehand (for example, 10 minutes or 30 minutes before the activity).

Another popular function of mobile terminals, navigation, provides the users with information about current locations of cars, optimal routes to chosen destinations and dynamic route guidance. Such information is received from a navigation system which basically traces the current location of a car and detects an optimal route to a destination using its own map data stored in a database.

The two important functions, schedule management and navigation, are implemented separately in mobile terminals. A conventional navigation function simply provides positioning and route guiding information, without interworking with the schedule management function. If a user has an appointment at a specific time, he or she generally estimates the time taken to go to the destination place given prior experience and leaves beforehand to arrive at the place on time for the appointment.

If the user has previously set an alarm for the departure time, he or she will leave to the destination when the alarm sounds. The user will then use the navigation function that guides an optimal route to the destination.

To provide navigation services through a navigation system, a traffic information center stores and manages road information and information about all mobile terminals that have requested the navigation services. The navigation system undergoes multiple communication processes, including an approval process, to provide road and navigation information received from the traffic information center to each mobile terminal. The users have to pay a communication fee whenever using the navigation services.

As explained above, conventional mobile terminals cannot interwork the scheduling and navigation functions. Accordingly, the users often move to a destination without having exact information about the time and optimal route to reach the destination. When estimating a departure time given prior experience, they may reach the destination at a time much later or earlier than the appointment time.

### SUMMARY OF THE INVENTION

Accordingly, the present invention has been made to solve the above-mentioned problems occurring in the prior art, and an object of the present invention is to provide a method for route guidance on a mobile terminal capable of interworking schedule management and navigation functions and thereby providing information helpful to reach a destination at a desired time.

In order to accomplish the above object of the present invention, there is provided a method for route guidance on a mobile terminal capable of interworking schedule management and navigation functions, which comprises the steps of: estimating an optimal route and a time to get to a destination based on schedule information inputted by a user; obtaining a departure time in consideration of the estimated time to get to the destination and setting an alarm for the departure time; generating an alarm when the departure time is reached; guiding the optimal route to the destination; calculating a remaining time to reach the destination according to the traveling speed of the user; and comparing the calculated time with the schedule information and outputting a route guiding message.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing the schematic structure of a mobile terminal having a schedule management function according to the present invention;

FIG. 2 is a flow chart showing a process of registering schedule information according to the present invention;

FIG. 3a illustrates the display of a mode for setting a navigation function to be implemented in connection with a schedule management function according to the present invention;

FIG. 3b illustrates the display of items under a “route setting” menu selected in the mode of FIG. 3a;

FIG. 3c illustrates the display of time information calculated according to the route setting in FIG. 3b;

FIG. 3d illustrates the display of an alarm time set for a schedule inputted in FIG. 3;

FIG. 4 is a flow chart showing a process of performing a schedule management function based on schedule information according to the present invention;

FIG. 5a illustrates the display of schedule information during a schedule alarm according to the present invention;

FIG. 5b illustrates the display of schedule information with a preset route during a schedule alarm according to the present invention;

FIG. 6 is a flow chart showing a process of guiding a route according to the present invention;

FIG. 7a illustrates a map displayed when timely arrival is expected;

FIG. 7b illustrates a map displayed according to a first embodiment of the present invention when a delay in arrival is expected; and

FIG. 7c illustrate a map displayed according to a second embodiment of the present invention when a delay in arrival is expected.

### DETAILED DESCRIPTION OF THE PREFERRED EMBODIMENT

Hereinafter, preferred embodiments of the present invention will be described with reference to the accompanying drawings. In the drawings, the same element, although depicted in different drawings, will be designated by the same reference numeral or character. Also, in the following description of the present invention, a detailed description of known functions and configurations incorporated herein will be omitted when it may make the subject matter of the present invention unclear.

The present invention provides a mobile terminal capable of interworking a navigation function with a schedule management function. If a user previously registers schedule information including the origin, destination, appointment date/time and schedule alarm time, the mobile terminal will automatically generate an alarm when the schedule alarm time is reached on the date of appointment. Also, the mobile terminal displays an optimal route to the destination and time information to help the user to reach the destination at a desired time. To display the time information (for example, remaining time to reach the destination), the mobile terminal measures the traveling speed of the user and calculates the remaining time to reach the destination based on the measured traveling speed.

When the preset schedule alarm sounds, the user can be alerted of the time to leave for the destination. While moving to the destination, the user can be provided with optimal route and time information helpful to arrive at the destination place on time.

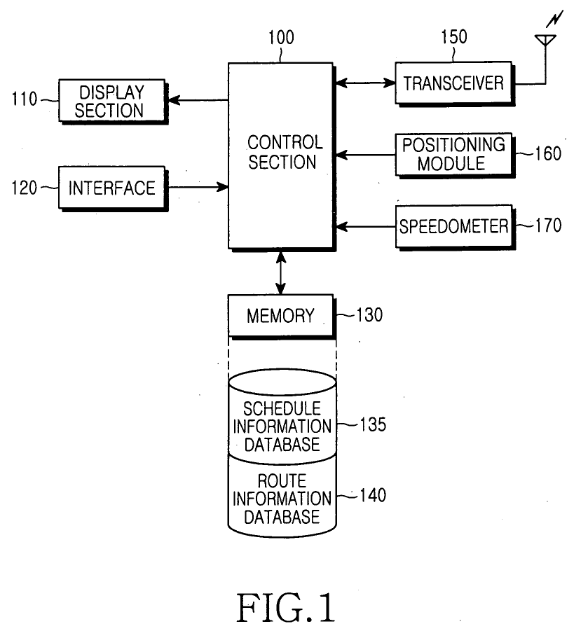

Hereinafter, a schedule management function that provides information about departure and arrival times for a schedule on a mobile terminal capable of interworking schedule management and navigation functions will be explained with reference to FIG. 1. FIG. 1 is a block diagram of a mobile terminal having the schedule management function according to the present invention.

Referring to FIG. 1, a control section 100 controls overall operations of the mobile terminal, including wireless communication and data processing. The control section 100 registers a schedule inputted by the user and alerts the user of a preferable departure time which is obtained in consideration of an estimated time to get to the destination. When the user leaves to the destination, the control section 100 measures the traveling speed of the user to generate time information based on the measured speed and informs the user of the remaining time to reach the destination.

The control section 100 performs the following operations for the schedule registration and management. When the schedule management function is selected, the control section 100 inputs the date, time, scheduled appointment or task, schedule alarm time and alarm sound as set by the user. This input process is identical to that generally done in a schedule input mode of conventional mobile terminals. The control section 100 outputs the preset alarm sound when the preset schedule alarm time is reached, thereby alerting the user of the departure time for the scheduled appointment or task.

According to the present invention, a route setting menu is provided to interwork the schedule management and navigation functions. When the user selects the route setting menu, the control section 100 displays a mode for inputting information such as the origin, destination, means of travel and desired arrival time on a display section 110.

Based on the information inputted by the user, the control section 100 estimates an optimal route and a time to get to the destination. Also, the control section 100 obtains a preferable departure time in consideration of the estimated time to get to the destination. The user can then set a desired alarm time to be alerted of the departure time.

More specifically, the control section 100 registers points of origin and destination, means of travel and desired arrival time. The registration of points refers to the input of detailed location information of the two specific points on the map in relation to the user's schedule. To input the detailed location information, the user can select the origin and destination points either from a list of points stored in the mobile terminal or on the map displayed on the display section 110. Upon the registration of points, the user's traveling route to the destination point can be marked on the displayed map.

As a means of travel to the destination point from the origin point, the user can select travel by car, bus, subway, other public transportation or on foot. When the user plans to travel by two or more means (for example, by car and on foot), it is possible to register the two or more selected means of travel.

The desired arrival time refers to the time at which the user wishes to arrive at the destination point for the scheduled appointment or task. The desired arrival time can be the basis of calculating times such as a departure time, remaining time to reach the destination and expected arrival delay.

When the user inputs schedule information such as appointment place and time in the schedule input mode, the route setting menu is additionally provided so that the user can select interworking with a navigation function. If the user sets a specific route in relation to the inputted schedule, the control section 100 will interwork the schedule management and navigation functions based on the route set by the user.

When the preset schedule alarm time is reached, the control section 100 displays the schedule information and at the same time generates an alarm to alert the user of the departure time. When the user leaves for the destination point, the control section 100 measures the traveling speed of the user from the origin point and estimates an expected arrival time based on the measured speed. The control section 100 displays the measured traveling speed, expected arrival time and remaining time to reach the destination on the display section 110. In addition, the control section 100 compares the expected arrival time with the desired arrival time to determine and display a possible arrival delay on the display section 110.

The display section 110 displays the origin/destination points, means of travel and desired arrival time inputted in the route setting menu, as well as the scheduled appointment, appointment date/time, schedule alarm time and alarm sound inputted in the schedule input mode, under the control of the control section 100. Particularly, when the navigation function is implemented in association with the schedule management function, the display section 110 displays a map changing along the movement of the user (i.e., the user's traveling route) and time information based on the traveling speed, such as remaining time to reach the destination.

An interface 120 is an input means providing an interface between the user and the mobile terminal. The interface 120 applies data corresponding to a key input to the control section 100. Then the control section 100 analyzes the key input data and performs a function according to the data.

A memory 130 connected to the control section 100 includes a program memory that stores various programs for controlling the operations of the mobile terminal and a data memory that temporarily stores data generated during implementation of the programs. The memory 130 also includes a schedule information database 135 for storing schedule information inputted for schedule management (such as a scheduled appointment or task, scheduled date/time, schedule alarm time, alarm sound and route setting information) and a route information database 140 for storing map data necessary to perform the navigation function. The route setting information may include at least one of the origin, destination, means of travel, desired arrival time and route guiding information.

A transceiver 150 separately processes a navigation signal received through an antenna and a signal from a mobile communication system. The transceiver 150 enables communication between the mobile terminal and a navigation service providing server. The transceiver 150 transmits a request for route calculation inputted from the mobile terminal and information necessary for the route calculation to the server and receives the results of route calculation from the server.

A positioning module 160 calculates the current location of the mobile terminal using a positioning system such as GPS, and provides the calculated location to the control section 100. More specifically, a GPS receiver included in the positioning module 160 receives a GPS signal transmitted from a plurality of satellites, calculates the current location of the mobile terminal and transfers the location information to the control section 100.

A speedometer 170 measures the traveling speed when the user moves with the mobile terminal. For example, when the user is walking to the destination on foot, the speedometer 170 measures the user's average walking pace through personal navigation and calculates the walking speed based on the walking pace. When the user drives a car with the mobile terminal, the speedometer 170 then measures the driving speed.

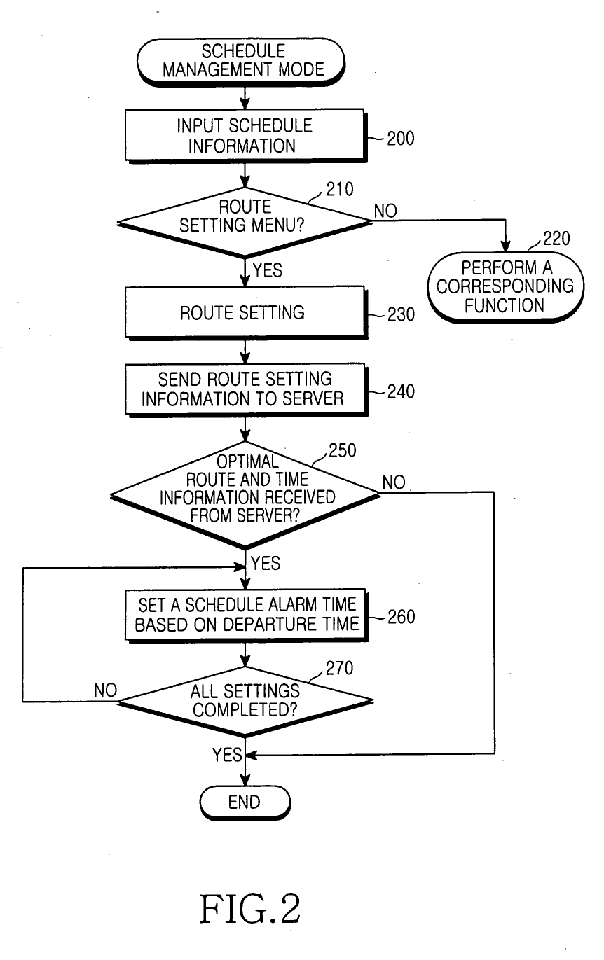

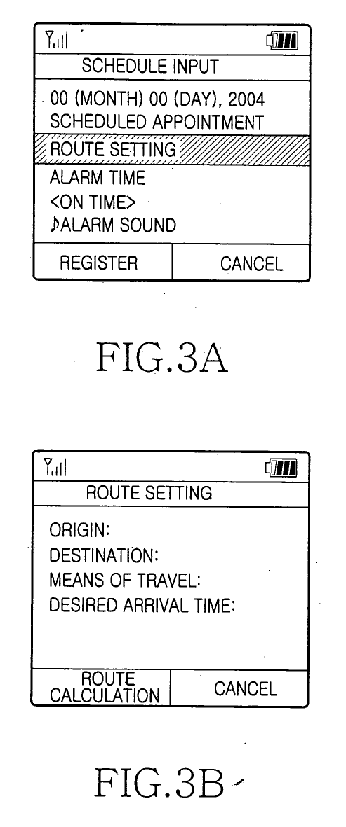

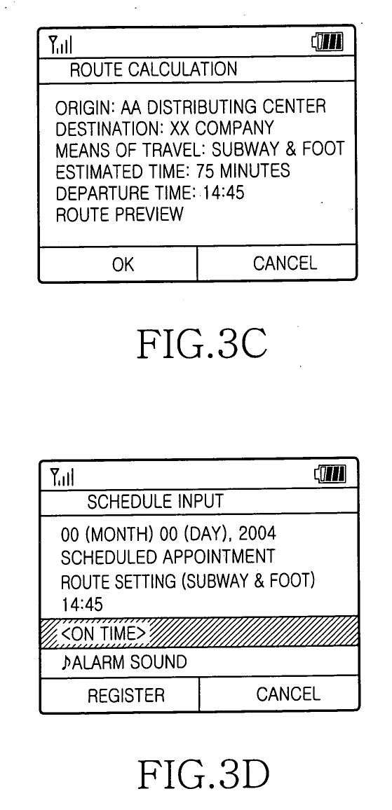

Hereinafter, a process of registering schedule information according to the present invention will be explained in detail with reference to FIGS. 2 and 3a to 3d. FIG. 2 is a flow chart showing a process of registering schedule information according to the present invention. FIG. 3a illustrates the display of a mode for setting a navigation function to be implemented in connection with a schedule management function according to the present invention. FIG. 3b illustrates the display of items under a “route setting” menu selected in the mode of FIG. 3a. FIG. 3c illustrates the display of time information calculated according to the route setting in FIG. 3b. FIG. 3d illustrates the display of an alarm time set for a schedule inputted in FIG. 3. Referring to FIG. 2, the user can initiate a schedule input mode by selecting a “schedule input” menu. At step 200, the control section 100 allows the user to input schedule information in the schedule input mode. The schedule information includes the scheduled date, time, place and appointment or task and a brief note on the schedule. Upon input of the schedule information, the control section 100 detects whether the user has selected a “route setting” menu as shown in FIG. 3a at step 210. Route setting is a function to interwork the schedule management and navigation functions. Through the route setting, the user can be notified of the departure time for a previously registered schedule at a preset schedule alarm time and provided with an optimal route to the destination, together with information as to whether the user can get to the destination prior to or at the desired arrival time at the current traveling speed.

If the route setting is not selected at step 210, the control section 100 will proceed with step 220 to perform a general function followed by the schedule registration. If the user has inputted the scheduled date, time and appointment or task and set a schedule alarm time and a desired alarm sound, the mobile terminal will only generate an alarm at the previously set alarm time to alert the user of the schedule, as generally done in conventional mobile terminals having a schedule management function.

Otherwise, if the route setting is selected at step 210, the control section 100 will proceed with step 230 to display a mode for inputting detailed information for route setting as illustrated in FIG. 3b. The user can input the origin, destination, means of travel and desired arrival time in the route setting mode. It is necessary to input the means of travel from the origin to the destination in order to receive information about an optimal route to the destination. The user may select travel by car, public transportation (such as bus or subway), foot or a combination of two or more means. When the user selects public transportation, one of bus or subway which is recommended to shorten the travel time will be displayed as the means of travel. Such a recommended means of travel can be determined using map data stored in the mobile terminal or through a communication with the navigation server.

The optimal route and estimated time to get to the destination are obtained based on the schedule information inputted by the user. Then, a preferable departure time can be obtained in consideration of the estimated time to get to the destination. When the user sets a schedule alarm, the mobile terminal generates an alarm when the previously set alarm time is reached, thereby alerting the user of the departure time.

In order to estimate the time to get to the destination and obtain the departure time, it is necessary to measure the speed of traveling by each means of travel. It is assumed that the traveling speed is an average speed of each means of travel. For example, when the user selects travel on foot, an average walking pace of the user which has been previously stored in the mobile terminal is used to obtain the time information. More specifically, pace information previously inputted by the user in a specific menu or that obtained from a previous travel on foot and stored in the memory 130 can be used. People have varying walking paces or speeds. They may have different times taken to the same destination even if they started from the same place at the same time. Therefore, it will be helpful to each user to know the remaining time to reach the destination based on the current traveling speed while moving to the destination.

If the user inputs all items, including a desired arrival time, under the route setting menu, the control section 100 will determine whether the user has pressed a predetermined key for route calculation. If the key is pressed, the control section 100 will proceed with step 240 to send the inputted route setting information to the server. In other words, the control section 100 requests for route calculation by sending the route setting information inputted by the user to the server. Subsequently, the control section 100 detects whether optimal route and time information corresponding to the route setting information has been received from the server.

When the optimal route and time information is received from the server, the control section 100 outputs the received information to the display section as illustrated in FIG. 3c. The optimal route to the destination is obtained based on the map data from the origin to the destination. The user can see the optimal route to the destination by selecting a preview function or implementing the navigation function. Time to get to the destination is estimated in consideration of the means of travel from the origin to the destination and the desired arrival time. As illustrated in FIG. 3c, the time information includes an estimated time to get to the destination and a departure time preferable to reach the destination on time.

The departure time calculated based on the desired arrival time is displayed as illustrated in FIG. 3c. When the user presses a key to confirm the displayed information, the control section 100 completes the route setting as illustrated in FIG. 3d and proceeds with step 260 to allow the user to set a schedule alarm based on the calculated departure time. According to the preferred embodiments of the present invention, the user can set the schedule alarm at the departure time or beforehand (for example, “on time,” “10 minutes before” and “30 minutes before”). After setting of the schedule alarm, the control section 100 proceeds with step 270 to determine whether the schedule information has been inputted with all necessary settings. The control section 100 then stores the schedule information in the schedule information database 135 of the memory 130.

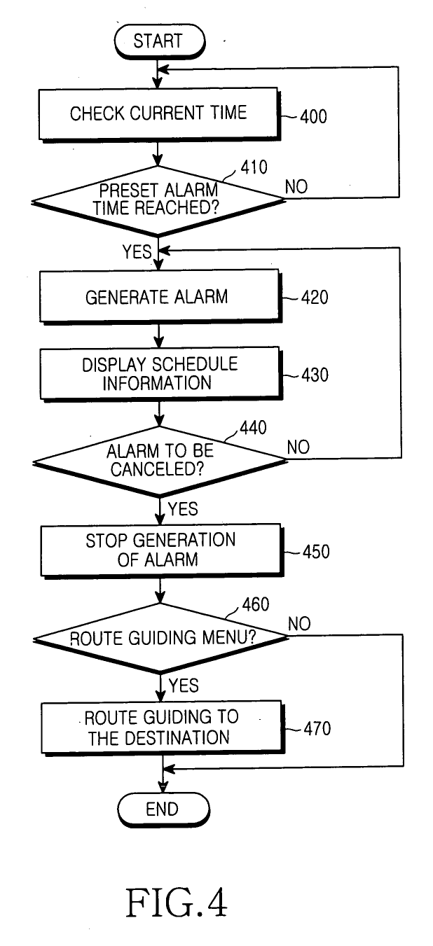

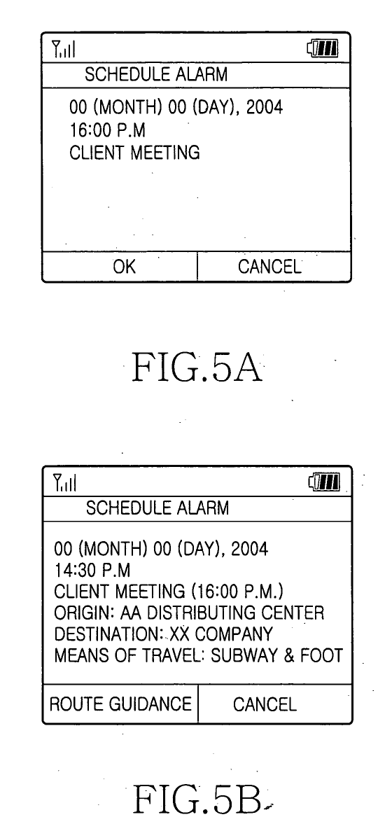

Hereinafter, a process of performing a schedule management function based on schedule information according to the present invention will be explained in detail with reference to the flow chart of FIG. 4. At step 400, the control section 100 periodically checks the current time while performing a schedule management function. At step 410, the control section 100 determines whether the schedule alarm time which has been set during registration of the schedule information is reached. When the schedule alarm time is reached, the control section 100 generates the preset alarm sound. In other words, if a schedule alarm has been previously set, the control section 100 generates a preset alarm sound or vibration at the schedule alarm time to alert the user of the schedule. At the same time, the control section 100 output the schedule information to the display section as illustrated in FIG. 5a. The control section 100 also confirms whether there is any related route setting information. If the route setting information is detected, the control section 100 outputs the schedule information together with the route setting information as illustrated in FIG. 5b. FIG. 5b illustrates the display of schedule information indicating that a client meeting is scheduled for 16:00 p.m. at XX company and that a preferable departure time is 14:30 p.m. to reach the destination place on time by subway and bus. Simultaneously with the display of the schedule information, the control section 100 outputs the preset alarm sound. At step 440, the control section 100 determines whether the user has pressed a key to confirm the displayed schedule information and thereby cancel the alarm. When the key is pressed, the control section 100 stops the generation of the alarm sound at step 450. As illustrated in FIG. 5b, a route guiding menu is provided at the low part of the displayed schedule information. The control section 100 determines whether the user has selected the route guiding menu at step 460. If the route guiding menu is selected, the control section 100 will proceed with step 470 to perform a route guidance to the destination using the route setting information.

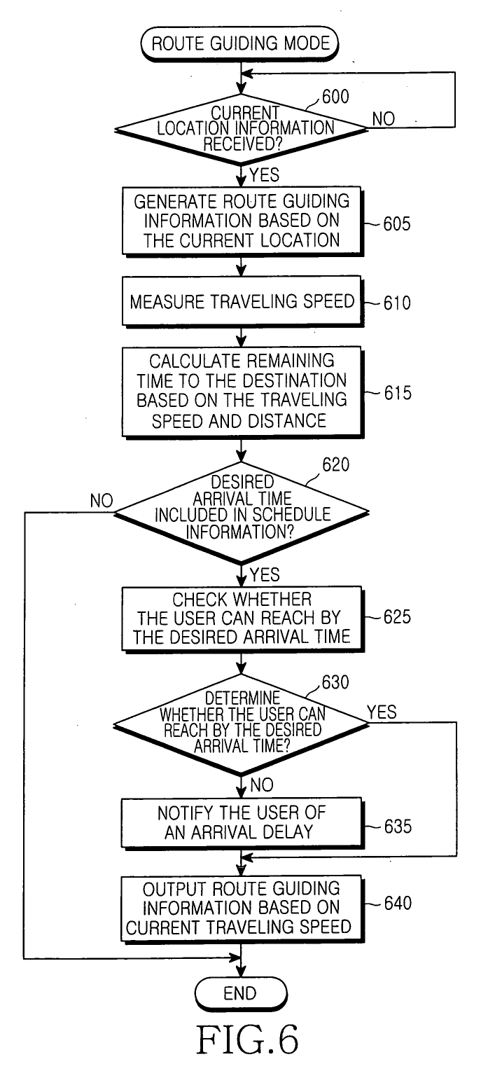

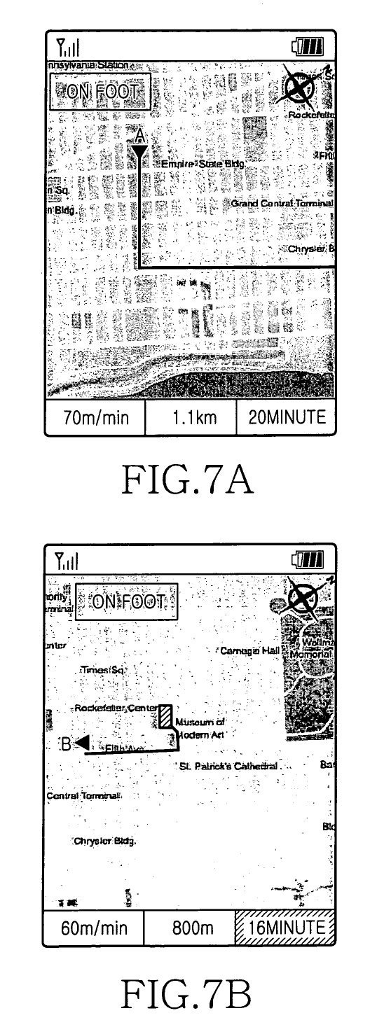

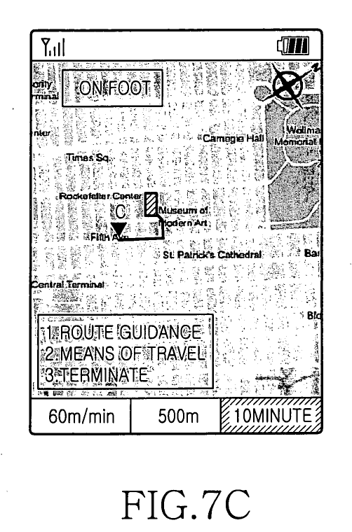

Hereinafter, a process of guiding a route to the destination will be explained in detail with reference to FIGS. 6 and 7a to 7c. FIG. 6 is a flow chart showing a process of guiding a route according to the present invention. FIG. 7a illustrates a map displayed when timely arrival is expected. FIG. 7b illustrates a map displayed according to a first embodiment of the present invention when a delay in arrival is expected. FIG. 7c illustrate a map displayed according to a second embodiment of the present invention when a delay in arrival is expected.

When the user selects a route guiding function after the schedule alarm, the control section 100 changes the current mode of the mobile terminal to a route guiding mode and proceeds with step 600 to determine whether the positioning module 160 has received current location information from the GPS satellites. When the current location information is received, the control section 100 proceeds with step 605 to generate route guiding information based on the current location information. More specifically, the control section 100 generates the route guiding information based on the received current location information and the route information received from the server and stored in the route information database 140 of the memory 130.

At step 610, the control section 100 controls the speedometer 170 to measure the traveling speed of the user in order to calculate the remaining time to reach the destination at the current speed. For example, when the user walks to the destination according to the route guidance provided by the mobile terminal, the speedometer 170 measures an average walking speed of the user. Then the control section 100 proceeds with step 615 to calculate the distance from the current location to the destination based on the measured traveling speed (i.e., walking speed) and the time left until the user reaches the destination.

Subsequently, the control section 100 compares the calculated time with the schedule information and outputs a route guiding message. To be specific, the control section 100 determines whether a desired arrival time set by the user is included in the schedule information at step 620. If a desired arrival time is included, the control section 100 will compare the calculated time left to reach the destination with the desired arrival time at step 625 and will proceed with step 630 to determine whether it is possible to reach the destination by the desired arrival time at the current traveling speed. If the control section 100 determines that the user can reach the destination by the desired arrival time, it will output route guiding information based on the current traveling speed on the map displayed on the display section as illustrated in FIG. 7a.

If the user has set two different means of travel, the distance and remaining time to take the next means of travel, instead of the distance and remaining time to reach the destination, will be displayed during the travel by the current means. Also, the point of transfer to the next means of travel will be indicated on the map so as to inform the user of the scheduled change of travel means at that point. For example, if the user first takes a bus and will then walk to the destination, information about the bus stop where the user has to take off will be displayed. At this time, the user can also confirm the distance from the bus stop to the destination and the remaining time to reach the destination by selecting a predetermined menu.

Since people have varying walking paces or speeds, they may have different times taken to the same destination even if they started from the same place at the same time. It is very helpful to each user to know the remaining time to reach the destination based on the current traveling speed while moving to the destination. The control section 100 indicates the user's traveling route on the displayed route guiding map, together with the current means of travel, traveling speed, distance to the destination and remaining time to the destination. From such information, the user can determine whether it is possible to reach the destination by the desired arrival time and whether the traveler should increase or decrease speed.

If the control section 100 determines that the user cannot reach the destination by the desired arrival time at step 630, it will proceed with step 635 to inform the user of an expected arrival delay. As an alert for the arrival delay, the remaining time to reach the destination can be highlighted or indicated in a distinguishing color as illustrated in FIG. 7b. Alternatively, the expected arrival delay can be additionally indicated at the lower part of the route guiding map. Simultaneously with the indication of the expected arrival delay, it is also possible to output a voice message (for example, “You will reach XX minutes later than the desired arrival time at the current speed”).

If the remaining time to reach the destination by the current means of travel is longer or greater than a critical value that shows an excessive arrival delay, the control section 100 will determine that the user cannot reach the destination by the desired arrival time even at a higher traveling speed. Then the control section 100 will display a menu for requesting information about another means of travel as illustrated in FIG. 7c. In other words, if the user cannot reach the destination by the desired arrival time, he or she can select the menu and request for a new route via another means of travel. For example, if the control section 100 determines that the user will reach the destination far behind the schedule at the current walking pace, it will inform the user of a faster means of travel, such as bus or subway, to reach the destination as soon as possible.

As explained above, the mobile terminal according to the present invention outputs an alarm sound to alert the user of the departure time when the preset schedule alarm time is reached. When the user selects the route guidance, the mobile terminal then implements the navigation function that interworks with the schedule management function. More specifically, the mobile terminal generates route guiding information based on its current location and the route setting information stored when schedule information is registered. The mobile terminal displays the distance from the current location to the destination and the remaining time to reach the destination in realtime on the route guiding map. When the user has selected travel on foot, he or she can walk along the route indicated on the displayed map. The mobile terminal keeps on measuring the walking pace of the user and updates the pace information at predetermined intervals in order to calculate the remaining time to the destination based on the current location information and the pace information in realtime. The user can check the distance and remaining time to the destination or a point of transfer at the current walking pace.

The mobile terminal compares the desired arrival time with the expected arrival time at the current speed to determine whether the user can reach the destination by the desired arrival time. If the user takes a single means of travel (for example, walking on foot), the mobile terminal will determine whether the user can reach the destination by the desired arrival time based only on the estimated time of arrival. On the other hand, if the user takes two means of travel (for example, by bus and on foot), the mobile terminal will determine whether the user can reach the destination by the desired arrival time based on both the expected time to arrive at the point of transfer and the expected time to arrive at the destination. The control section 100 determines whether the user has selected a combination of two or more means of travel during the route setting. If the user has selected travel by bus and on foot, the control section 100 will first measure the speed of bus. At this time, the control section 100 may use an average speed of bus that has been previously stored in the mobile terminal. The control section 100 estimates the time to reach the point of transfer based on the speed of bus and displays the current traveling speed, distance and time to reach the point of transfer. When the user arrives at the point of transfer and starts to walk, the control section 100 measures the walking pace of the user and calculates the time to reach the destination from the point of transfer.

The mobile terminal estimates the expected arrival time at predetermined intervals. When it is determined that the user cannot reach the destination by the desired arrival time at the current traveling speed, the mobile terminal displays the digits or column indicating the remaining time to reach the destination in a distinguishing color. The mobile terminal may also outputs a voice message as an alert for the arrival delay so that the user can hurry to reach the destination by the desired arrival time.

According to the present invention, the mobile terminal provides schedule management based on the estimated time to get to the destination and an alert for the preferable departure time by interworking the schedule management and navigation functions. When the user walks to the destination, the mobile terminal guides a route to the destination, estimating the remaining time to reach the destination which varies according to the walking pace or speed of the user. Therefore, the user can effectively manage time using the route guidance according to the present invention.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for route guidance on a mobile terminal capable of interworking schedule management and navigation functions, which comprises the steps of:
estimating an optimal route and a time to get to a destination based on schedule information inputted by a user;
obtaining a departure time in consideration of the estimated time to get to the destination and setting an alarm for the departure time;
generating an alarm when the departure time is reached;
guiding the optimal route to the destination;
calculating a remaining time to reach the destination according to the traveling speed of the mobile terminal; and
comparing the calculated time with the schedule information and outputting a route guiding message.

2. The method as claimed in claim 1, wherein said schedule information includes at least one of a scheduled appointment, scheduled date and time, schedule alarm time, desired alarm sound and route setting information.

3. The method as claimed in claim 1, wherein said route setting information includes at least one of an origin, destination, means of travel, desired arrival time and route guiding information.

4. The method as claimed in claim 3, wherein said means of travel is any of car, bus, subway, public transportation and foot.

5. The method as claimed in claim 1, wherein registration of said schedule information includes:
determining whether a route setting menu is selected to implement a navigation function in connection with the inputted schedule information; and
when the route setting menu is selected, inputting route setting information.

6. The method as claimed in claim 5, further comprising the steps of:
sending the route setting information which includes an origin, destination, means of travel, desired arrival time to a navigation server; and
receiving information about a departure time obtained in consideration of the time to get to the destination and an optimal route from the server.

7. The method as claimed in claim 1, wherein said estimation of the time to get to the destination includes:
determining whether at least one means of travel has been selected;
measuring a speed of the selected means of travel; and
calculating the remaining time to reach the destination based on the measured speed.

8. The method as claimed in claim 1, further comprising the steps of:
determining whether a desired arrival time has been set;
if the desired arrival time has been set, comparing the remaining time to reach the destination with the desired arrival time;
determining whether a user can reach the destination by the desired arrival time; and
if it is determined that the user cannot reach the destination by the desired arrival time, notifying the user of an arrival delay.

9. The method as claimed in claim 8, wherein said arrival delay is notified through output of a voice message.

10. The method as claimed in claim 8, further comprising the step of requesting for information about a new route when it is determined that the user cannot reach the destination by the desired arrival time.

11. The method as claimed in claim 10, further comprising the step of requesting for information about a new route via another means of travel.
